(19) United States
(12) Patent Application Publication
(10) Pub. No.: US 2025/0122756 A1
(43) Pub. Date: Apr. 17, 2025

(54) GATE SYSTEM

(71) Applicant: Kenneth Mak, Yaumatei (HK)

(72) Inventor: Kenneth Mak, Yaumatei (HK)

(21) Appl. No.: 18/378,929

(22) Filed: Oct. 11, 2023

(51) Int. Cl. E05F 15/635; E05D 15/06; E06B 11/02

(52) U.S. Cl. CPC E05F 15/635; E06B 11/026; E06B 11/045

(57) ABSTRACT

A gate system includes a plurality of gate portions, including at least a first gate portion and a second gate portion. A motor includes a drive shaft and a first pinion secured to the drive shaft. A first gate portion includes a first rack configured to be driven by the first pinion. The first gate portion further includes a second pinion rotatably secured to a wheel of the first gate portion. The second gate portion includes a second rack configured to be driven by the second pinion. The second rack may be selectively coupled with or uncoupled from the second pinion by way of a clutch gear.

### BACKGROUND OF DISCLOSURE

The present disclosure relates generally to a gate system. For example, a gate system of the present disclosure may be used to guard an entrance for vehicles, such as automobiles.

### SUMMARY OF DISCLOSURE

An aspect of the present disclosure is directed to a gate system comprising a base; a first rail extending horizontally over the base; a second rail extending horizontally over the base, the second rail being parallel to the first rail; a motor secured to the base, the motor including a drive shaft and a first pinion secured to the drive shaft; a first gate portion including a lower end having a first plurality of wheels configured to roll along the first rail, a first rack configured to be driven by the first pinion, and a second pinion rotatably secured to a wheel selected from the first plurality of wheels; and a second gate portion including a lower end having a second plurality of wheels configured to roll along the second rail, and a second rack configured to be driven by the second pinion.

In some embodiments, the gate system further comprises a clutch gear configured to selectively couple the second pinion with the second rack.

In some embodiments, the clutch gear and the second pinion gear have a gear ratio that causes the second gate portion to travel along the second rail at twice the speed of the first gate portion along the first rail.

In some embodiments, the clutch gear may be manually disengaged from the second pinion and the second rack.

In some embodiments, the gate system further comprises a tower extending upwardly from the base, and a first plurality of rollers supported at an upper end of the tower, wherein the upper end of the first gate portion has a channel configured to receive the first plurality of rollers.

In some embodiments, the first gate portion includes a second plurality of rollers supported on the first gate portion; and an upper end of the second gate portion has a channel configured to receive the second plurality of rollers.

In some embodiments, the tower includes at least four posts.

In some embodiments, the gate system further includes a third rail extending horizontally over the base, the third rail being parallel to the first rail and the second rail.

In some embodiments, the gate system further includes a third gate portion configured to move along the third rail.

In some embodiments, the gate system further includes a third pinion rotatably secured to a wheel selected from the second plurality of wheels, a third plurality of rollers supported on the second gate portion, and the third gate portion including an upper end having a channel configured to receive the third plurality of rollers, a lower end having a third plurality of wheels configured to roll along the third rail, and a third rack configured to be driven by the third pinion.

In some embodiments, the gate system further comprises at least one position sensor configured to detect a position of the first gate portion or the second gate portion, and a controller in communication with the at least one position sensor and the motor and configured to send a signal to the motor based on a sensed position of the first gate portion or the second gate portion.

In some embodiments, each of the first rail and the second rail includes a foot portion, a head portion above the foot portion, and an aluminum layer extending over at least the head portion, wherein the aluminum layer is configured to engage the respective first plurality of wheels or second plurality of wheels.

In some embodiments, each wheel of the first set of wheels is made of a material including steel.

In some embodiments, each roller of the first plurality of rollers is made of at least one material including nylon.

In some embodiments, each roller of the second plurality of rollers is made of at least one material including nylon.

Another aspect of the present disclosure is directed to a system comprising: a motor including a drive shaft and a first pinion secured to the drive shaft; a first gate portion including a lower end having a first plurality of wheels configured to roll along a first rail, a first rack configured to be driven by the first pinion, and a second pinion rotatably secured to a wheel selected from the first plurality of wheels; and a second gate portion including a lower end having a second plurality of wheels configured to roll along a second rail, and a second rack configured to be driven by the second pinion.

In some embodiments, the system further comprises a base; a first rail extending horizontally over the base; and a second rail extending horizontally over the base, the second rail being parallel to the first rail.

In some embodiments, the system further comprises a clutch gear configured to selectively couple the second pinion with the second rack.

In some embodiments, the clutch gear and the second pinion gear have a gear ratio that causes the second gate portion to travel along the second rail at twice the speed of the first gate portion along the first rail.

In some embodiments, the clutch gear may be manually disengaged from the second pinion and the second rack.

In some embodiments, the system further comprises a tower extending upwardly from the base, and a first plurality of rollers supported at an upper end of the tower, wherein the upper end of the first gate portion has a channel configured to receive the first plurality of rollers.

In some embodiments, the first gate portion includes a second plurality of rollers supported on the first gate portion; and wherein an upper end of the second gate portion has a channel configured to receive the second plurality of rollers.

In some embodiments, the tower includes at least four posts.

In some embodiments, the system further includes a third rail extending horizontally over the base, the third rail being parallel to the first rail and the second rail.

In some embodiments, the system further includes a third gate portion configured to move along the third rail.

In some embodiments, the system further includes a third pinion rotatably secured to a wheel selected from the second plurality of wheels, a third plurality of rollers supported on the second gate portion, and the third gate portion including an upper end having a channel configured to receive the third plurality of rollers, a lower end having a third plurality of wheels configured to roll along the third rail, and a third rack configured to be driven by the third pinion.

In some embodiments, the system further comprises at least one position sensor configured to detect a position of the first gate portion or the second gate portion, and a controller in communication with the at least one position sensor and the motor and configured to send a signal to the motor based on a sensed position of the first gate portion or the second gate portion.

In some embodiments, each of the first rail and the second rail includes a foot portion, a head portion above the foot portion, and an aluminum layer extending over at least the head portion, wherein the aluminum layer is configured to engage the respective first plurality of wheels or second plurality of wheels.

In some embodiments, each wheel of the first set of wheels is made of a material including steel.

In some embodiments, each roller of the first plurality of rollers is made of at least one material including nylon.

In some embodiments, each roller of the second plurality of rollers is made of at least one material including nylon.

Another aspect of the present disclosure is directed to a method of operating a gate system or another system of the present disclosure, the method comprising operating the controller to cause the motor to rotate the drive shaft in a first direction to move the first gate portion in a first direction along the first rail, thereby causing the second gate portion to move along the second rail in the first direction.

In some embodiments, the motor causes the first gate portion to move at a first speed along the first rail, and movement of the first gate portion along the first rail causes the second gate portion to move along the second rail at a second speed, the second speed being at least twice the magnitude of the first speed.

In some embodiments, the method further comprises decoupling the second pinion from the second rack to allow the second gate portion to be moved independently of the first gate portion.

In some embodiments, the gate system further comprises a clutch gear configured to selectively couple the second pinion with the second rack, and decoupling the second pinion from the second rack is caused by moving the clutch gear along its axis out of engagement with at least one of the second pinion and the second rack.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a front view of an embodiment of a gate system according to the present disclosure;

FIG. 2 is a top view of the embodiment of FIG. 1;

FIG. 3 is a cross-sectional view of a rail of the gate system of FIG. 1;

FIG. 4 is an end view of the gate system of FIG. 1;

FIG. 5 is a top view of a second embodiment of a gate system according to the present disclosure; and

FIG. 6 is an end view of the gate system of FIG. 5.

### DETAILED DESCRIPTION

This disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The present disclosure relates to a gate system for a secure site. Examples of a secure site include a government facility, a corporate campus, a residential property, or another site requiring security.

Generally, the secure site includes a perimeter that prevents or limits access to the site, so the site may be accessed by authorized individuals only. The perimeter may have a wall or another fixed barrier with at least one access point located along the wall or other barrier to allow vehicles and/or people to enter or exit the secure site.

The present disclosure provides a gate system for use at an access point of a perimeter for a secure site. The gate system may be selectively opened to allow passage of vehicles or people through the access point or may be selectively closed to prevent passage of vehicles and people through the access point.

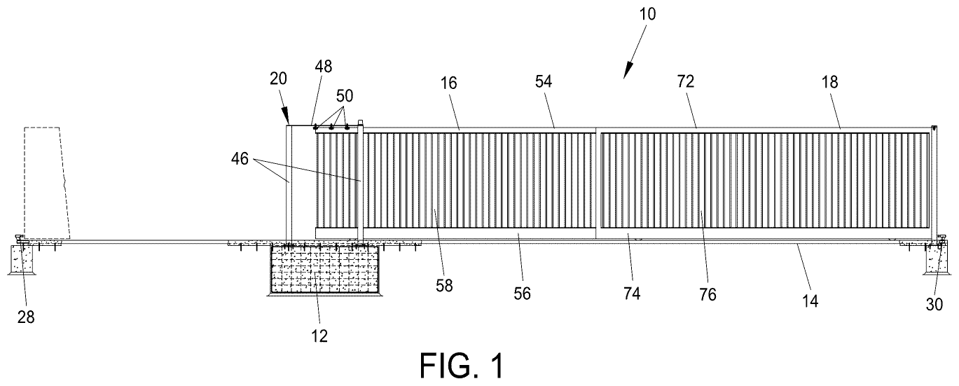

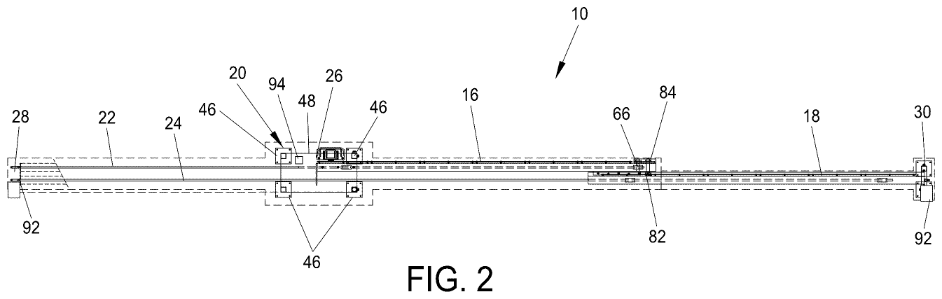

Referring to FIGS. 1 and 2, an embodiment of a gate system of the present disclosure is generally indicated at 10. The gate system 10 is supported on a base 12. A pathway 14 extends over the base 12. The pathway 14 may include a driveway, a road, a walking path, or another opening. Vehicles and people may travel along the pathway 14 when the gate system 10 is open. The gate system 10 includes a first gate portion 16 (or first gate panel 16) and a second gate portion 18 (or second gate panel 18) that are supported in a forward-and-back direction by a frame 20 and vertically by a first rail 22 and a second rail 24, respectively. The rails 22, 24 are disposed on the ground and the base 12, and are configured to support the first gate portion 16 and the second gate portion 18, respectively. The first gate portion 16 and the second gate portion 18 are movable in a horizontal direction along the first rail 22 and the second rail 24, respectively, from an open position to a closed position to allow a user to open and close the gate system 10.

The gate system 10 is shown in the closed position in FIGS. 1 and 2. When the gate portions 16, 18 of the gate system 10 are closed, the gate system 10 provides a sturdy barrier to prevent people and/or vehicles from traversing the pathway at which the gate system is located. As will be described in greater detail below, the gate portions 16, 18 can be moved to the open position to allow people and/or vehicles to pass through along the pathway 14.

Referring to FIG. 2, the first gate portion 16 and the second gate portion 18 are configured to be moved by a motor 26 or manually, as described in more detail below. The first gate portion 16 may travel between a first position in which one side of the first gate portion 16 is at a first travel limit 28 of the gate system to the position shown in FIGS. 1 and 2. The second gate portion 18 may travel between a first position in which one side of the second gate portion 18 is at the first travel limit 28 of the gate system and a second position in which an opposite side of the second gate portion 18 is at the second travel limit 30 of the gate system.

The dimensions of the first gate portion 16 and the second gate portion 18 and the travel distances of the first gate portion 16 and the second gate portion 18 may be selected for a particular gate system 10 to allow people and/or vehicles to pass through the pathway 14 of the gate system 10 when the gate system is open. For example, gate systems according to the present disclosure that are designed for selectively allowing automobiles to pass through the pathway may have longer gate portions 16, 18 and greater travel distances gate portions than narrower gate systems that are only sufficiently wide to allow people to pass through the pathway.

As mentioned above, the base 12 supports the components of the gate system 10 and may be formed of various materials. In some embodiments, the base 12 includes concrete, metal, and/or another material. The base 12 may be secured to an adjacent barrier, such as a wall. The base 12 is sufficiently firm to support the first rail 22, the second rail 24, and additional rails if needed.

The first rail 22 is configured to support the first gate portion 16 as the first gate portion travels 16 along the first rail 22, as described in more detail below. The second rail 24 is configured to support the second gate portion 18 as the second gate portion 18 travels along the second rail 24, as described in more detail below. The first rail 22 and the second rail 24 are substantially parallel to each other.

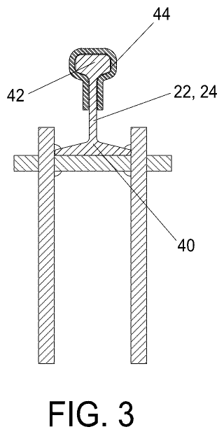

In one embodiment, the rails 22, 24 are constructed to reduce noise of the gate system 10. Referring to FIG. 3, each rail 22, 24 includes a foot portion 40, a head portion 42 above the foot portion 40, and an aluminum layer 44 disposed over at least the head portion 42. The aluminum layer 44 is configured to engage the wheels of the respective gate portion that the rail supports. Due to the material properties of aluminum, the aluminum layer 44 reduces the amount of noise of the wheels traveling over the rail. In some embodiments, the aluminum layer 44 is made of aluminum 6063-T5. The aluminum cap on the rail is advantageous, because it resists corrosion and it provides quieter operation when harder wheels (e.g. wheels made of steel) roll along the aluminum cap of the rail.

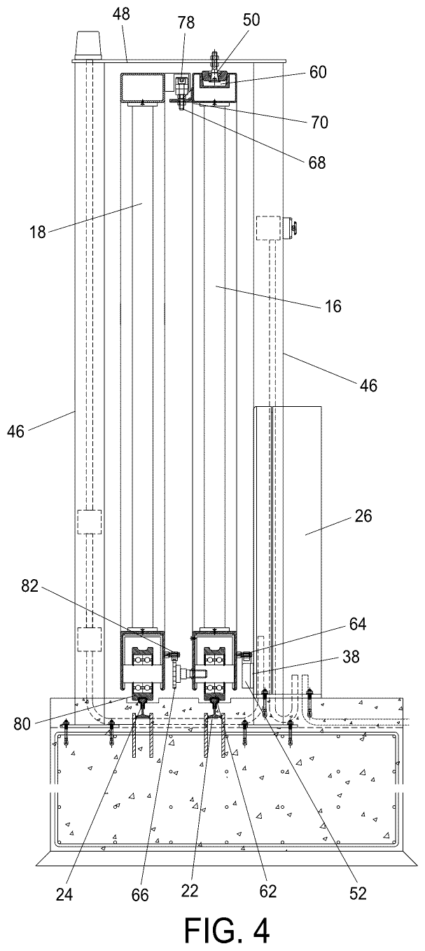

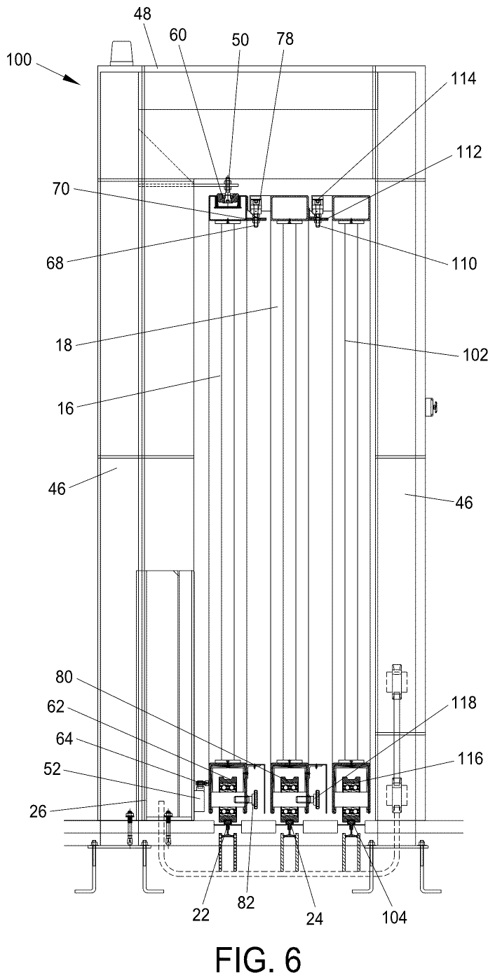

The frame 20 supports the gate portions 16, 18 and maintains the gate portions in an upright position while the gate portions 16, 18 are seated on the rails 22, 24. The frame 20 includes a tower having four posts, each indicated at 46, extending upwardly from the base 12. Each post 46 includes a lower end secured to the base 12 and an upper end secured to a plate 48 (as shown in FIG. 1). The plate 48 may be configured to extend over the first gate portion 16 and the second gate portion 18 when the gate system 10 is fully opened and the gate portions 16, 18 are adjacent the first travel limit 28. A plurality of rollers, hidden in FIGS. 1 and 2, and indicated at 50 in FIGS. 4 and 6, are supported on a lower side of the plate 48. Each roller 50 is free to rotate about an axis and to engage an upper end of the first gate portion 16, as described in more detail below. The rollers 50 may be made of one or more materials including metal or a polymer. In some embodiments, the rollers are made of a material including nylon.

The motor 26 is secured to the base 12 and is adjacent to the tower of the frame 20. In FIG. 2, the motor 26 is positioned near one of the posts 46 of the tower, thereby shielding the motor 26 from being impacted by objects traveling through the gate system 10 when the gate system 10 is in an open position.

As shown in FIG. 4, the motor 26 includes a drive shaft 38 and a first pinion 52 secured to the drive shaft 38. The first pinion 52 is configured to drive the first gate portion 16, as described in more detail below.

The motor 26 may have a power output that is selected based on the desired performance of the gate system 10. For example, the motor 26 may be selected based on the weight of the gate portions 16, 18 and based on the desired speed of the gate portions 16, 18 when the motor 26 is being operated to open or close the gate system 10.

The first gate portion 16 includes an upper end and a lower end. The first gate portion 16 is supported at its lower end by the first rail 22 and at its upper end by the frame 20. Movement of the first gate portion along the first rail 22 may be caused by the motor 26, which is coupled to the first gate portion 16, as described below.

As shown in FIG. 1, the first gate portion 16 includes a first horizontally extending beam 54 at the upper end of the first gate portion 16 and a second horizontally extending beam 56 at the lower end of the first gate portion 16. A plurality of bars, indicated at 58, extend vertically between the first horizontally extending beam 54 and the second horizontally extending beam 56. Gaps between the vertically extending bars 58 allow a user to see from one side of the first gate portion 16 to the other. In other embodiments, solid panels may be provided in place of the bars 58 to block the view from one side of the first gate portion 16 to the other side of the first gate portion.

As shown in FIG. 4, a channel 60 is defined along a length of the upper end of the first gate portion 16 and is configured to receive the first plurality of rollers 50, which are secured to the plate 48 of the frame 20. As the first gate portion 16 translates along the first rail 22, the first plurality of rollers 50 roll within the channel 60 and maintain the vertical orientation of the first gate portion 16 with respect to the frame 20 and the base 12.

A plurality of wheels, indicated at 62, are secured to the lower end of the first gate portion 16. The plurality of wheels 62 are configured to roll along the first rail 22. In some embodiments, each wheel 62 may be made of one or more materials including metal and/or other materials. In some embodiments, each wheel 62 is made of steel. Steel is less noisy than other materials would be when the wheel 62 rolls over the aluminum layer 44 of the rail 16.

The lower end of the first gate portion 16 includes a first rack 64, which is configured to be driven by the first pinion 52 of the motor 26. The first rack 64 includes teeth that are configured to mesh with teeth of the first pinion 52. In this way, clockwise rotation of the motor drive shaft 38 causes the first gate portion 16 to translate along the first rail 22 in a first direction, and counterclockwise rotation of the motor drive shaft 38 causes the first gate portion to translate along the first rail 22 in a second direction that is opposite to the first direction.

To drive motion of the second gate portion 18, the second gate portion 18 includes a second pinion 66, which is rotatably secured to a wheel selected from the first plurality of wheels 62.

As shown in FIG. 4, the first gate portion 16 further includes a second plurality of rollers, indicated at 68, secured to a flange 70 extending from an upper end of the first gate portion 16. The rollers 68 are configured to stabilize the upper end of the second gate portion 18, as described in more detail below. In some embodiments, each roller 68 of the second plurality of rollers 68 is made of at least one material including nylon.

The second gate portion 18 is supported at its lower end by the second rail 24 and at its upper end by the first gate portion 16. Movement of the second gate portion 18 along the second rail 24 may be caused by movement of the first gate portion 16 along the first rail 22 when the second gate portion 18 and the first gate portion 16 are coupled to one another, as discussed in more detail below. The user may selectively uncouple the second gate portion 18 from the first gate portion 16 to move the second gate portion 18 manually and independently from the first gate portion, as described in more detail below.

As shown in FIG. 1, the second gate portion 18 includes a first horizontally extending beam 72 at the upper end of the second gate portion 18 and a second horizontally extending beam 74 at the lower end of the second gate portion 18. A plurality of bars 76 extend vertically between the first horizontally extending beam 72 and the second horizontally extending beam 74. Gaps between the vertically extending bars 76 allow a user to see from one side of the second gate portion to the other. In other embodiments, solid panels may be provided in place of the bars 76 to block the view from one side of the second gate portion 18 to the other side of the second gate portion.

As shown in FIG. 4, a channel 78 is secured along a length of the upper end and is configured to receive the second plurality of rollers 68 of the first gate portion 16. As the second gate portion 18 translates along the second rail 24, the second plurality of rollers 68 roll within the channel 78 and maintain the vertical orientation of the second gate portion 18 with respect to the first gate portion 16.

The channel 78 is inverted, so the rollers 68 engage the channel 78 from below. The inverted channel 78 helps conceal the rollers 68 from view, thereby improving the aesthetic appearance of the gate system. The inverted channel 78 also shields the rollers 68 from the elements, such as rain or debris, which could damage or inhibit operation of the rollers 68.

A plurality of wheels, indicated at 80, are secured to the lower end of the second gate portion 18. The plurality of wheels 80 are configured to roll along the second rail 24. In some embodiments, each wheel 80 may be made of one or more materials including metal and/or other materials. In some embodiments, each wheel 80 is made of steel. Steel is less noisy than other materials would be when the wheel rolls over the aluminum of the rail.

The lower end of the second gate portion 18 includes a second rack 82, which is configured to be driven by the second pinion 66 of the first gate portion 16 via a clutch gear 84 (FIG. 1), which selectively couples the second pinion 66 to the second rack 82, as described below. The second rack 82 includes teeth that are configured to mesh with teeth of the clutch gear 84.

FIG. 2 shows the clutch gear 84 having an axis parallel to the axis of the second pinion 66. A user may selectively uncouple the second gate portion 18 from the first gate portion 16. When the clutch gear 84 is disengaged from the second rack 82, a user may manually push the second gate portion 18 along the second rail 24 without having to move the first gate portion 16 along the first rail 22. To move the second gate portion 18 along the rail 24 when the second gate portion 18 is coupled to the first gate portion 16 by the second pinion 66, the clutch gear 84, and the second rack 82, a user must overcome the resistance to motion of the second gate portion 18 due to the inertia of the motor 26 and the weight of the first gate portion 16. To move the second gate portion 18 along the second rail 24 when the second gate portion 18 is uncoupled from the first gate portion 16, the user must only overcome the static friction and the rolling friction of the second gate portion 18 along the second rail 24.

The clutch gear 84 includes a handle to allow a user to manually disengage the clutch gear 84 from the second pinion 66 and the second rack 82. A user pulls the handle of the clutch gear 84 to slide the clutch gear 84 along its axis to disengage the clutch gear 84 from the second pinion 66. To couple the clutch gear 84 and the second pinion 66, the user pushes the handle in the opposite direction.

In some embodiments, the clutch gear 84 and the second pinion 66 have a gear ratio that causes the second gate portion 18 to travel faster than the first gate portion 16. In some embodiments, the clutch gear 84 and the second pinion 66 have a gear ratio that causes the second gate portion 18 to travel at twice the speed of the first gate portion 16.

The gate system includes position sensors, each indicated at 92, located at the first travel limit 28 and the second travel limit 30. The sensors 92 are configured to detect positions of the gate portions 16, 18. The gate system includes a controller 94 in communication with the sensors 92 and the motor 26. In various embodiments of the gate system 10, the controller 94 may be in wired and/or wireless communication with the sensors 92 and the motor 26. The controller 94 is configured to send a signal to the motor 26 based on a sensed position of the first gate portion 16 or the second gate portion 18. For example, the controller 94 is configured to send a signal to the motor to shut off when the second gate portion 18 reaches the second travel limit 30 or when the second gate portion reaches the first travel limit 28.

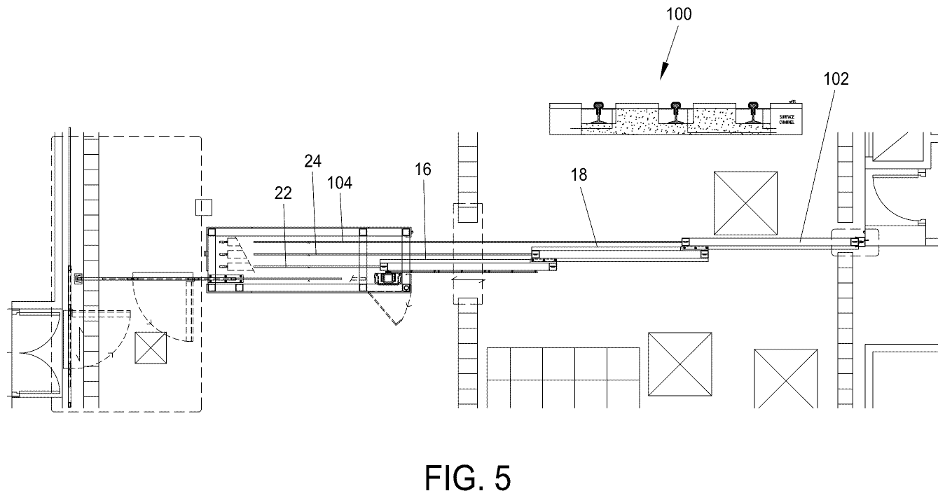

Some embodiments of a gate system of the present disclosure may include more than two gate portions. For example, FIG. 5 shows an embodiment of a gate system, generally indicated at 100, including a third gate portion 102, in addition to the first gate portion 16 and the second gate portion 18. In FIG. 5, the gate system 100 includes similar features as the gate system 10 of FIG. 1, with like numbers indicating like features. The third gate portion 102 is configured to travel along a third rail 104.

To drive motion of the third gate portion 102, the second gate portion 18 of the gate system 100 further includes a third pinion (not shown), which is rotatably secured to a wheel selected from the second plurality of wheels 80.

As shown in FIG. 6, the second gate portion 18 further includes a third plurality of rollers 110 secured to a flange 112 extending from an upper end of the second gate portion 18. The rollers 110 are configured to stabilize the upper end of the third gate portion 102, as described in more detail below. In some embodiments, each roller 110 of the second plurality of rollers 110 is made of at least one material including nylon.

Similar to the first gate portion 16 and the second gate portion 18, the third gate portion 102 includes a first horizontally extending beam at the upper end of the third gate portion 102 and a second horizontally extending beam at the lower end of the third gate portion 102. A plurality of bars extend vertically between the first horizontally extending beam and the second horizontally extending beam. Gaps between the vertically extending bars allow a user to see from one side of the third gate portion to the other. Solid panels may be provided in place of the bars.

A channel 114 is secured along a length of the upper end of the third gate portion 102 and is configured to receive the third plurality of rollers 110 of the second gate portion 18. As the third gate portion 102 translates along the third rail 104, the third plurality of rollers 110 roll within the channel 114 and maintain the vertical orientation of the third gate portion 102 with respect to the second gate portion 18.

The channel 114 is inverted, so the rollers 110 engage the channel 114 from below. The inverted channel 114 helps conceal the rollers 110 from view, thereby improving the aesthetic appearance of the gate system. The inverted channel 114 also shields the rollers 110 from the elements, such as rain or debris, which could damage the rollers 110.

A plurality of wheels, indicated at 116, are secured to the lower end of the third gate portion 102. The plurality of wheels 116 are configured to roll along the third rail 104. In some embodiments, each wheel may be made of one or more materials including metal and/or other materials. In some embodiments, each wheel is made of steel. Steel is less noisy than other materials would be when the wheel rolls over the aluminum of the rail.

The lower end of the third gate portion 102 includes a third rack 118, which is configured to be driven by the third pinion of the second gate portion. The third rack includes teeth that are configured to mesh with teeth of the third pinion.

Various controllers may execute various operations discussed above. For example, as discussed above, the controller, such as controller 94, may control the components of the gate system 10, including the motor 26, amongst other operations. Using data stored in associated memory and/or storage, the controller 94 may execute one or more instructions stored on one or more non-transitory computer-readable media, which the controller 94 may include and/or be coupled to, that may result in manipulated data. In some examples, the controller 94 may include one or more processors or other types of controllers. In one example, the controller 94 is or includes at least one processor. In another example, the controller 94 performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

As described above, gate systems of the present disclosure have various advantages over prior art gate systems. For example, gate systems of the present disclosure are quiet because of the materials used for the wheels and the rails along which the wheels travel. Gate systems of the present disclosure are configured for optional manual operation, which may be desirable during power outages. Gate systems of the present disclosure include movable gate portions that are supported by a frame so the gate portions are resistant to tipping. Gate systems of the present disclosure are suitable for providing a secure gate on pathways of various widths.

Having thus described several aspects of at least one embodiment of this disclosure, it is to be appreciated various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

What is claimed is:

1. A gate system comprising:
a base;
a first rail extending horizontally over the base;
a second rail, separate from the first rail, extending horizontally over the base, the second rail being spaced from and parallel to the first rail;
a motor secured to the base, the motor including a drive shaft and a first pinion secured to the drive shaft;
a first gate portion including
a lower end having a first plurality of wheels configured to roll along the first rail,
a first rack configured to be driven by the first pinion, and
a second pinion rotatably secured to a wheel selected from the first plurality of wheels; and
a second gate portion including
a lower end having a second plurality of wheels configured to roll along the second rail, and
a second rack configured to be driven by the second pinion.

2. The gate system of claim 1, further comprising a clutch gear configured to selectively couple the second pinion with the second rack.

3. The gate system of claim 2 wherein the clutch gear and the second pinion gear have a gear ratio that causes the second gate portion to travel along the second rail at twice the speed of the first gate portion along the first rail.

4. The gate system of claim 2, wherein the clutch gear may be manually disengaged from the second pinion and the second rack.

5. The gate system of claim 1, further comprising
a tower extending upwardly from the base, and
a first plurality of rollers supported at an upper end of the tower,
wherein the upper end of the first gate portion has a channel configured to receive the first plurality of rollers.

6. The gate system of claim 5, wherein the first gate portion includes a second plurality of rollers supported on the first gate portion; and
wherein an upper end of the second gate portion has a channel configured to receive the second plurality of rollers.

7. The gate system of claim 5, wherein the tower includes at least four posts.

8. The gate system of claim 1, further including
a third rail extending horizontally over the base, the third rail being parallel to the first rail and the second rail.

9. The gate system of claim 8, further including
a third gate portion configured to move along the third rail.

10. The gate system of claim 9, further including
a third pinion rotatably secured to a wheel selected from the second plurality of wheels,
a third plurality of rollers supported on the second gate portion, and
the third gate portion including
an upper end having a channel configured to receive the third plurality of rollers,
a lower end having a third plurality of wheels configured to roll along the third rail, and
a third rack configured to be driven by the third pinion.

11. The gate system of claim 1, further comprising
at least one position sensor configured to detect a position of the first gate portion or the second gate portion, and
a controller in communication with the at least one position sensor and the motor and configured to send a signal to the motor based on a sensed position of the first gate portion or the second gate portion.

12. The gate system of claim 1, wherein each of the first rail and the second rail includes
a foot portion,
a head portion above the foot portion, and
an aluminum layer extending over at least the head portion, wherein the aluminum layer is configured to engage the respective first plurality of wheels or second plurality of wheels.

13. The gate system of claim 10, wherein each wheel of the first plurality of wheels, the second plurality of wheels and the third plurality of wheels is made of a material including steel.

14. The gate system of claim 10, wherein each roller of the first plurality of rollers, the second plurality of rollers and the third plurality of rollers is made of at least one material including nylon.

15. (canceled)

16. A method of operating the gate system of claim 11, the method comprising:
operating the controller to cause the motor to rotate the drive shaft to move the first gate portion in a first direction along the first rail, thereby causing the second gate portion to move along the second rail in the first direction.

17. The method of claim 16, wherein the motor causes the first gate portion to move at a first speed along the first rail, and movement of the first gate portion along the first rail causes the second gate portion to move along the second rail at a second speed, the second speed being at least twice the magnitude of the first speed.

18. The method of claim 16, further comprising decoupling the second pinion from the second rack to allow the second gate portion to be moved independently of the first gate portion.

19. The method of claim 18,
wherein the gate system further comprises a clutch gear configured to selectively couple the second pinion with the second rack, and
wherein decoupling the second pinion from the second rack is caused by moving the clutch gear along its axis out of engagement with at least one of the second pinion and the second rack.
